(19) United States
(12) Patent Application Publication
(10) Pub. No.: US 2006/0218107 A1
(43) Pub. Date: Sep. 28, 2006

(54) Method for controlling a product production process

(75) Inventor: Timothy M. Young, Knoxville, TN (US)

Correspondence Address: LUEDEKA, NEELY & GRAHAM, P.C., P O BOX 1871, KNOXVILLE, TN, 37901, US

(73) Assignee: The University of Tennessee Research Foundation

(21) Appl. No.: 11/088,651

(22) Filed: Mar. 24, 2005

(51) Int. Cl. G06N 3/00; G06N 3/12; G06F 15/18; C01F 15/00; C01G 43/00

(52) U.S. Cl. 706/13

(57) ABSTRACT

A method for controlling a production process involving selection of process variables affecting product characteristics and using genetic algorithms to modify a set of seed neural networks based upon the process variables to an create an optimal neural network model. A commercial statistical software package may be used to select the process variables. Real-time process control data are fed into the optimal neural network model and used to calculate a projected product characteristic. A production control operator uses the list of process variables and knowledge of associated process control settings to control the production process.

### FIELD

This invention relates to the field of production process control. More particularly, this invention relates to the use of computer-generated models for predicting end product properties based upon material properties and process control variables.

### BACKGROUND

The manufacture of many structured materials, such as engineered wood products involves utilizing raw materials that have a high degree of variability in their physical and chemical properties. For example, the physical and chemical characteristics of the wood veneers, strands, and chips that are used to create engineered products vary widely in terms of the nature of the wood fiber (hardwood or softwood and particular tree species), fiber quality, wood chip and fiber dimensions, moisture content, mat forming consistency, density, tensile and compressive strength, and so forth. A factory that manufactures products such as plywood, oriented strand board, particle board and so forth from these raw materials typically must adapt its manufacturing processes to accommodate a wide range of these raw material properties. The resulting end products must have adequate end product properties such as internal bond (IB) strength, modulus of rupture (MOR) strength, and bending stiffness (Modulus of Elasticity*Cross Section Moment of Inertia, or EI). Two other very important considerations from an economic perspective are factory throughput quantity and raw material usage rates. Various process control settings may be adjusted to compensate for differences in raw material properties and to control the economic parameters. For example, various combinations of mat core temperature and various process stages, resin percentages, line speeds, and pressing strategies (press closing characteristics) may be used to manage the production process. However, the manufacturing process involves thousands of machine variables and raw material parameters, some of which may change significantly several times a minute. At the time of production the quality of the product being produced is unknown because it cannot be determined until end product samples are tested. Several hours may elapse between production and testing, during which time unacceptable production may go undetected. Various process control technologies have been developed using electronic sensors, programmable logic controllers, and other automated systems in attempts to automatically control these processes. However, these automated systems often cannot incorporate common sense considerations that a skilled production operator has learned from years of experience. What is needed therefore are methods for analyzing high speed production processes for structured materials and providing appropriate process control data to operators who may then use the information to control the production processes.

### SUMMARY

In one embodiment the present invention provides a method for controlling a process for producing a product. The method begins by providing a set of seed neural networks corresponding to the process and then continues with using genetic algorithm software to genetically operate on the seed neural networks to predict a characteristic of the product made by the process. Then, based upon the predicted characteristic of the product, the process concludes by manually adjusting the process to improve the predicted characteristic of the product.

In another embodiment, a method is provided for controlling a process for producing a product. The method includes providing process variable data associated with a product characteristic data, a set of process variables that are influential in affecting a product characteristic, and seed neural networks incorporating the process variables and the product characteristic. The method further includes using genetic algorithm software to genetically operate on the seed neural networks and arrive at an optimal model for predicting the product characteristic based upon the process variable data associated with the product characteristic data. The method continues with inputting process control data from the product production process into the optimal model and using the process control data to calculate a projected product characteristic. Then, based on the projected product characteristic, the method concludes with manually adjusting at least one process variable to control the process.

A preferred embodiment provides a method for generating a neural network model for a product production process. The method includes providing a parametric dataset that associates process variable data with product characteristic data, and then generating a set of seed neural networks using the parametric dataset. The method also incorporates the step of defining a fitness fraction ranking order, genetic algorithm proportion settings, and a number of passes per data partition for a genetic algorithm software code. The method concludes with using the genetic algorithm software code to modify the seed neural networks and create an optimal model for predicting a product characteristic based upon the process variable data.

A further embodiment provides a method for controlling a product production process that includes providing a parametric dataset that associates process variable data with product characteristic data. The method further incorporates the steps of quasi-randomly generating a set of seed neural networks using the parametric dataset, and then using a genetic algorithm software code to create an optimal model from the set of seed neural networks. The method continues with inputting process control data from the product production process into the optimal model and using the process control data to calculate a projected product characteristic. Then, based on the projected product characteristic, the method concludes with adjusting at least one process variable to control the process.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 illustrates the overall framework of a data fusion structure according to the invention.

FIG. 2 illustrates a typical hardware configuration.

FIG. 3 is a flow chart of a method according to the invention.

FIG. 4 is a computer screen image depicting a mechanism for an operator to select a source data file.

FIG. 5 is computer screen image depicting a mechanism for an operator to select an end product for modeling.

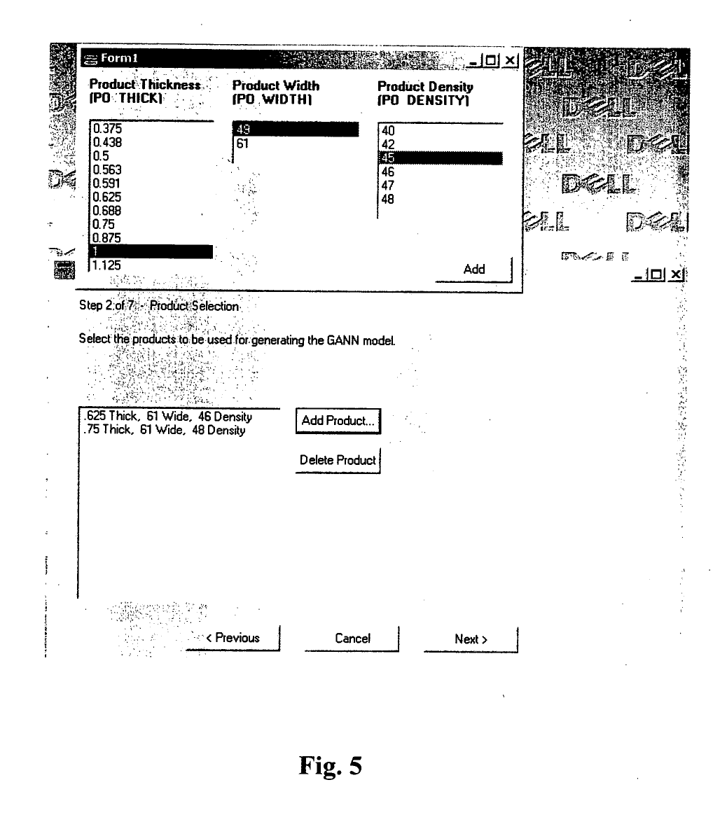

FIG. 6 is a computer screen image depicting a mechanism for an operator to pick a statistical method for selecting parameters to be used for modeling.

FIG. 7 is a computer screen image depicting a mechanism for an operator to pick parameters to be excluded from the neural network model.

FIG. 8 is a computer screen image depicting a mechanism for an operator to choose the number of parameters to be used for the model.

FIG. 9 is a computer screen image depicting a mechanism for an operator to choose start and end dates for data to be use to generate the model.

FIG. 10 is a computer screen image depicting a mechanism for an operator to choose advanced options for generating the model.

FIG. 11 is a computer screen image depicting the output of a neural network model.

FIG. 12 is a flow chart of a method for generating a neural network model for a product production process, according to the invention.

FIGS. 13-17 are example XY scatter plots of actual and predicted end product property values calculated according to the invention.

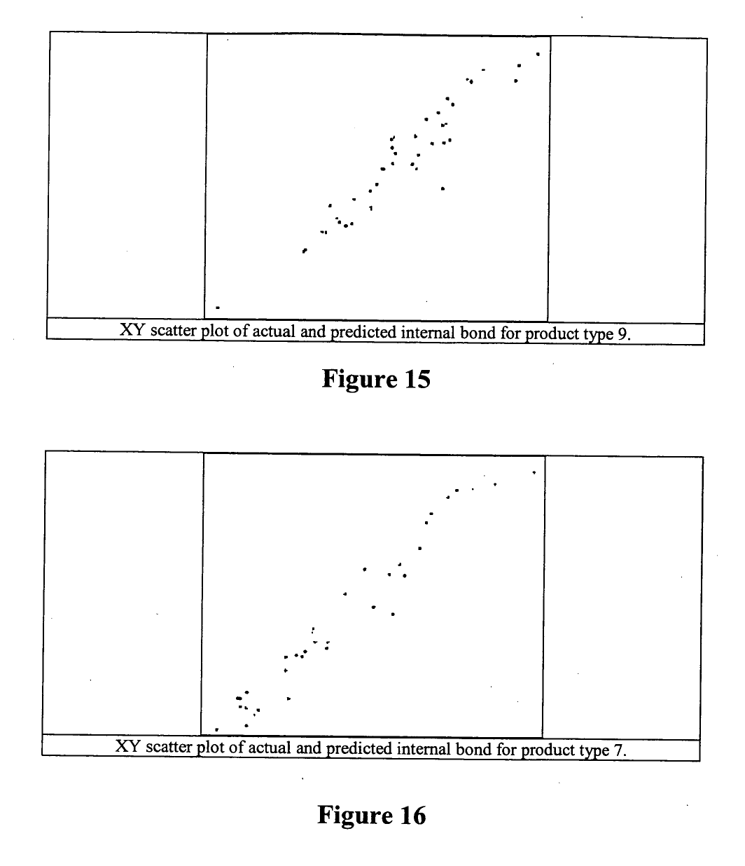

FIG. 18 is an example chart showing a time order comparison of predicted and actual end product property values.

### DETAILED DESCRIPTION

Data fusion or information fusion are names that are given to a variety of interrelated expert-system problems. Historically, applications of data fusion include military analysis, remote sensing, medical diagnosis and robotics. In general, data fusion refers to a broad range of problems which require the combination of diverse types of information provided by a variety of sensors, in order to make decisions and initiate actions. Preferred embodiments as described herein rely on a type of data fusion called distributed fusion. Distributed fusion (sometimes called track-to-track fusion) refers to a process of fusing together both observations (e.g., destructive test data) with target estimates supplied by remote fusion sources (e.g., real-time sensor data from a manufacturing line). Distributed data fusion is concerned with the problem of combining data from multiple diverse sensors in order to make inferences about a physical event, activity, or situation.

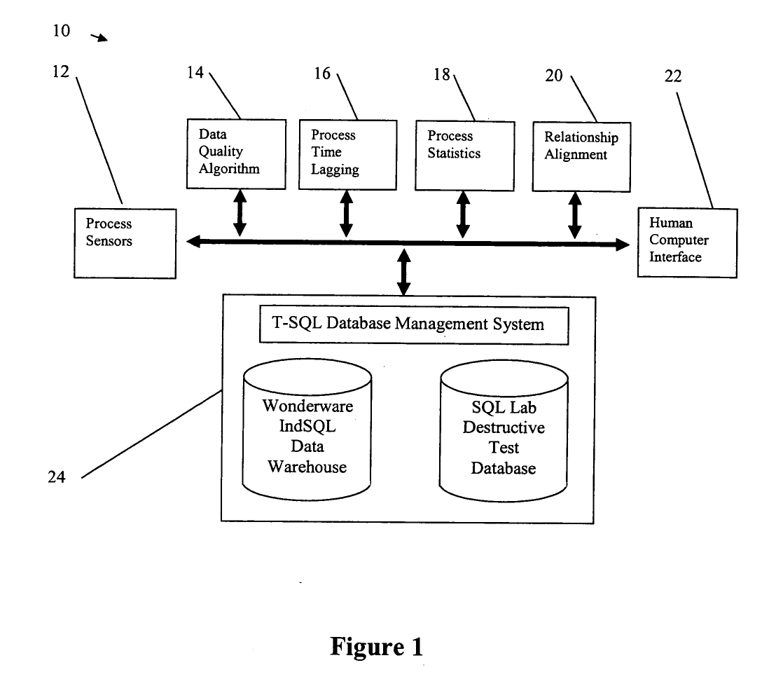

Data fusion techniques may be used for controlling a product production process. FIG. 1 illustrates the overall structure of the data fusion structure 10 in a preferred embodiment. A series of fusion sources 12-22 interact with a database management system 24. The first fusion sources are process monitoring sensors 12 which capture process variable data. Process variables preferably encompass material properties, including raw material properties and intermediate material properties, associated with materials that are used to produce the product. Process variables include such characteristics as raw material weight, density, volume, temperature, as well as such variables as raw and intermediate material consumption rates, material costs, and so forth. Intermediate material properties refers to properties of work in process between the raw material stage and the end product stage. Process variables may also include process control variables. Process control variables are process equipment settings such as line speed, roller pressure, curing temperature, and so forth. In summary, process variable data are measurements of process variables that are recorded, preferably on electronic media.

As a production process operates, product characteristics are determined in large part by the process variables. A product characteristic is, for example, a physical or chemical property of a product, such as internal bond (IB) strength, modulus of rupture (MOR) strength, and bending stiffness (Modulus of Elasticity*Cross Section Moment of Inertia, or EI). Typically such properties are measured using destructive and non-destructive tests that are conducted on end product material samples, and recorded as product characteristic data. Economic parameters such as product output rate (factory throughput and by-product and waste output rates) and product costs are also examples of product characteristics. Product characteristic data are measurements of product characteristics that are recorded, preferably on electronic media. The combination of process variable data (and the associated process variables) combined with corresponding measured product characteristic data (and the associated product characteristics) that reflect the production process form a parametric dataset that can be used to model the production process.

The most preferred embodiments incorporate a data quality filter 14 which discards obviously erroneous process variable data and product characteristics data, and identifies (and preferably recovers) missing data. Another fusion source that is generally important is process lag time 16. Process lag time 16 generally includes specific time reference information associated with data from process sensors 12. That is, the process lag time 16 records the precise time that process sensors 12 capture their data. This is important because manufacturing processes typically include planned (and, unfortunately, unplanned) time delays between processing steps. Variations in these time intervals often have a significant impact on product characteristics.

Another element of fusion source data is process statistics 18. Process statistics are calculated data that identify process control limits, trends, averages, medians, standard deviations, and so forth. These data are very important for managing the production control process. Another fusion source is relationship alignment 20. Relationship alignment refers to the process of aligning the time that the physical properties were created with the sensor data of the process at the time.

The final category of fusion source information is human computer interaction 22. Process control operators and production managers need real-time data on the production process as it is operating. “Real-time” data refers to process variable data that are reported synchronously with their generation. That is, in real-time data reporting the reporting of the data occurs at a constant, and preferably short, time lag from its generation. Not all data that are generated by process sensors need be reported in order to maintain a data stream that is considered real-time. In other words, a particular process control sensor may take a temperature reading approximately every six seconds. However, for example, only one of ten temperature readings may be reported or an average of ten temperatures reported. In this situation the reporting is still “real-time” under either the sampling or the averaging system if the sampled or averaged updated temperature data are reported approximately every sixty seconds. That is, reporting is considered “real-time” even if the data reports are delayed several minutes, or even longer, after the reported measurement or average measurement is taken. The process of recording a real-time process variable measurement on tangible media, such as a database management system, is called “updating” the process variable data.

Based upon the real-time data, the process control operator or production manager may order changes to process control settings. A process control setting is an adjustment of a control that changes a process variable. For example, a thermostat setting is a process control setting that changes a temperature process variable.

Most preferably, human computer interaction 22 also includes real-time reporting of at least one projected product characteristic. “Projected product characteristics” are estimates of future product characteristics that are projected based at least in part upon process variable data. Such projections are feasible because each product characteristic is a function of its associated process variable data, i.e., a function of the process variable data recorded for an end product during its production. In some embodiments “projected product characteristics” may include only one projected product characteristic, such as internal bond.

The fusion source information is stored and processed in the database management system 24. The most preferred embodiments utilize a Transaction—Structured Query Language (T-SQL) database access structure. T-SQL is an extended form of Structured Query Language (SQL) that adds declared variables, transaction control, error and exception handling and row processing to SQL's existing functions. Real-time process variable data are preferably stored in a commercial data warehouse computer. A “data warehouse” is an electronic copy of data, in this case manufacturing process and test data, that is specifically structured for query, analysis, and reporting. Data on product characteristics may also be stored in a data warehouse, or as depicted in FIG. 1, they may be stored in a separate database that is accessible by the database management system 24. The projected product characteristics may be stored in either the data warehouse or the test database.

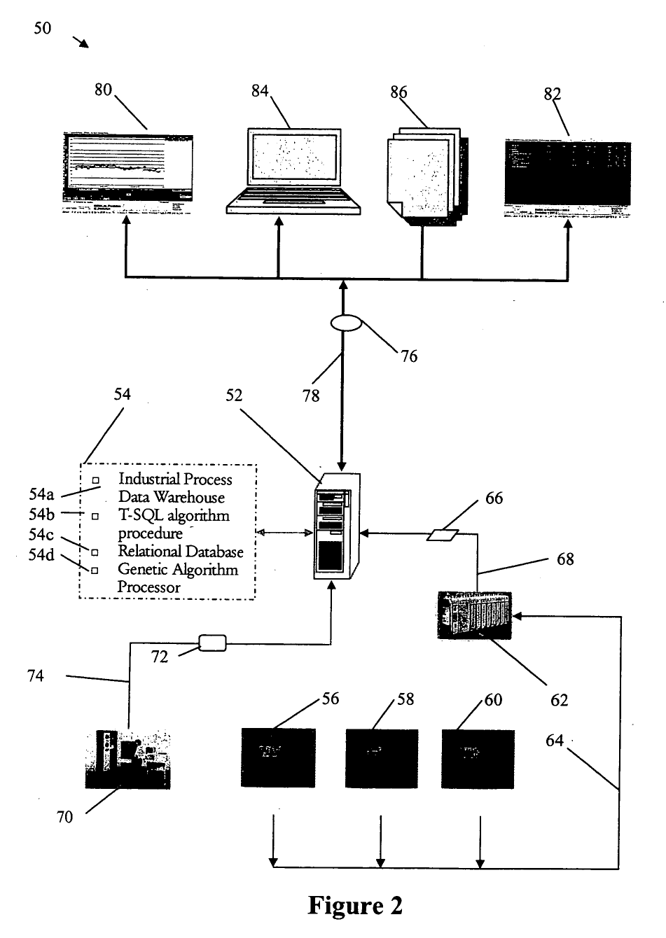

FIG. 2 illustrates a typical hardware configuration 50, according to preferred embodiments. The core of the system is a dedicated PC server 52 that accesses digital memory 54. Digital memory 54 includes a data warehouse 54a, relational database data storage 54c, as well as stored T-SQL algorithm procedures 54b and a genetic algorithm processor 54d (to be described later).

A series of process sensors 56, 58, 60 feed a programmable logic controller (PLC) array 62 through a PLC data highway 64. The PLC array 62 provides process variable data 66 to the PC server 52 through data transmission lines 68. Hardware configuration 50 also includes laboratory testers 70 that provide test results 72 to PC server 52 through a business or process Ethernet highway 74. Test results 72 are the results of testing a material sample. A material sample may be an end-product sample, an intermediate product sample, or even a by-product sample. The PC Server 52 stores the process variable data 66 and the data on product characteristics 72 in the digital memory 54. Preferably the process variable data 66 are stored in the data warehouse 54a of digital memory 54, and the data on product characteristics 72 are stored in the relational database 54d.

PC server 52 continually access digital memory 54 to calculate projected product characteristics 76 which are transmitted over the production plant's business or process local area network 78 and displayed as reports on production operator's PC client terminals 80, production management PC client terminals 82, and other client user terminals 84. Paper copies 86 of the reports may also be produced.

In the most preferred embodiments, PC Server 52 utilizes genetic algorithm (genetic algorithm) and neural network techniques to calculate the projected end property datasets 76. A neural network is a data modeling tool that is able to capture and represent complex input/output relationships. The goal is to create a model that correctly maps the input to the output using historical data so that the model can then be used to predict output values when the output is unknown.

Genetic algorithm analysis is a technique for creating optimum solution for non-trivial mathematical problems. The main premise behind the technique is that by combining different pieces of information relevant to the problem, new and better solutions can appear. Accumulated knowledge is used to create new solutions and these new solutions are refined and used again until some convergence criterion is met. Despite the considerable power and generality of the conventional neural network approach to process or system optimization, the method suffers from limitations for which no broadly applicable method provides complete resolution. Although the usual network training method (back propagation of error or one of its variants) will usually reach a solution, it may well be a non-optimum one. If such a solution is reached, the training mechanism has no protocol for abandoning it to search for a more nearly optimal one.

A central goal of the most preferred embodiments is to avoid the limitations of conventional neural network training methods and to remove essentially all constraints on network geometry. In the most preferred embodiments, genetic algorithm techniques are used to train an evolving population of neural networks regarding how to calculate the projected end property datasets 76. By using genetic algorithm techniques for training, the usual neural network training constraints are entirely eliminated because prediction performance improves as an inevitable consequence of retaining in the population, as each successive population is pruned, only the better performing networks that have resulted from prior genetic manipulations. A collateral result of eliminating the training constraints is the capability for conditioning networks with any distribution of processing elements and connections.

In preferred embodiments, preparation for the application of a genetic algorithm method to optimization of a process or system proceeds in three (generally overlapping) steps. The order in which these steps are taken depends upon the nature of the optimization task and personal preference. The first of these steps is the definition of one or more “fitness measures” that will be used to assess the effectiveness of evolved solutions. This step is the most critical of the three, as the evolutionary sequence, and thus the form of developed solutions, depends upon the outcomes of the many thousands or millions of fitness assessments that will be made during the execution of a genetic algorithm program. The fitness measures are nothing more than performance “scores” (usually normalized to unity) for one or more aspects of the task or tasks for which a genetically mediated solution is sought. The fitness measures generally assume the same forms for genetic algorithm applications as for any other optimization technique.

The second step is to contrive a “genetic representation” of the elements of the process or system to be optimized. The elements of this representation must satisfy three very broadly defined and intertwined conditions. First, they must be capable of representing the “primitives” from which genetically mediated solutions will be constructed. Second, the representation must codify (either explicitly or implicitly) the “laws” governing assembly of the primitives. Finally, the representation should lend itself to computationally efficient manipulation under a set of “genetic operations” (or operators).

The specification of the aforementioned “genetic operations” is the third and final preparatory step. These operations must perform the computational analogues of crossover, mutation, gene insertion, and the like, on the members of a population of processes or systems, a population in which each member is specified by a (generally) unique sequence of representational elements.

It is during execution of a Genetic Algorithm program that the “fitness measures”, “genetic representation”, and “genetic operations” are brought together so as to effect optimization of a process or system. In the preferred embodiments, the general form of such a genetic algorithm is as follows.

TABLE 1
Genetic Algorithm Method

| | |
|---|---|
| 1 | Create a seed population of entities assembled quasi-randomly from the genetic primitives. |
| 2 | Evaluate each entity in the population in terms of the fitness measures. If, for |
| | example, the entities are neural networks and if optimization is defined as the |
| | capability for computing the value of some material property on the basis of |
| | manufacturing process parameters, process each network in the context of |
| | representative data drawn from the manufacturing process and calculate values |
| | for the various fitness scores for each network. |
| 3 | If the population includes an entity whose performance, as determined from the |
| | fitness score(s) of (2), is adequate for some intended purpose, save the entity's |
| | definition and exit. |
| 4 | Rank the entities by a fitness measurement score in descending order. Note |
| | that, although this step is not strictly necessary, its inclusion can be used to |
| | advantage in making the choices described in (5) below. |
| 5 | Create a new generation of entities by applying the genetic operations to |
| | selected entities (or, in the case of sexual combination, pairs of entities). As |
| | required for computational efficiency, prune the population if its size exceeds |
| | some preset limit before generating the members of the new generation. |
| 6 | Return to 2 unless the system has reached the maximum J-score, i.e., when no |
| | further improvement in prediction is possible. |
| 7 | Record the “optimal” neural network model and it's “J-score.” |

In the most preferred embodiments, the genetic algorithm operation of Table 1 operates directly on a definition of a complete entity (i.e., on a network), or the definitions of two networks (in the case of mating), modifying the definition (or creating “offspring” in the case of mating) as directed by the definition of the operation. An entity (here, a network) is its own genetic representation. A typical example of such a representation is presented in Table 2

TABLE 2
Network Representation

| | |
|---|---|
| NetworkHeaderData | |
| NumExternalInputs | 12 |
| NumPredictedVals | 1 |
| NumInteriorPEs | 9 |
| NumPEs | 22 |
| NumWts | 108 |
| InteriorIndex0 | 12 |
| PredictedIndex0 | 21 |
| EndNetworkHeaderData | |
| NetworkData | |

| | | | | | | | |
|---|---|---|---|---|---|---|---|
| nPE | 0 | PEIndex | 0 | BiasFlag 0 | NumSrc 0 | Gain | 0.000000 ResponseFuncType0 |
| nPE | 1 | PEIndex | 1 | BiasFlag 0 | NumSrc 0 | Gain | 0.000000 ResponseFuncType0 |
| nPE | 2 | PEIndex | 2 | BiasFlag 0 | NumSrc 0 | Gain | 0.000000 ResponseFuncType0 |
| nPE | 3 | PEIndex | 3 | BiasFlag 0 | NumSrc 0 | Gain | 0.000000 ResponseFuncType0 |
| nPE | 4 | PEIndex | 4 | BiasFlag 0 | NumSrc 0 | Gain | 0.000000 ResponseFuncType0 |
| nPE | 5 | PEIndex | 5 | BiasFlag 0 | NumSrc 0 | Gain | 0.000000 ResponseFuncType0 |
| nPE | 6 | PEIndex | 6 | BiasFlag 0 | NumSrc 0 | Gain | 0.000000 ResponseFuncType0 |
| nPE | 7 | PEIndex | 7 | BiasFlag 0 | NumSrc 0 | Gain | 0.000000 ResponseFuncType0 |
| nPE | 8 | PEIndex | 8 | BiasFlag 0 | NumSrc 0 | Gain | 0.000000 ResponseFuncType0 |
| nPE | 9 | PEIndex | 9 | BiasFlag 0 | NumSrc 0 | Gain | 0.000000 ResponseFuncType0 |
| nPE | 10 | PEIndex | 10 | BiasFlag 0 | NumSrc 0 | Gain | 0.000000 ResponseFuncType0 |
| nPE | 11 | PEIndex | 11 | BiasFlag 0 | NumSrc 0 | Gain | 0.000000 ResponseFuncType0 |
| nPE | 12 | PEIndex | 12 | BiasFlag 1 | NumSrc 0 | Gain | 0.000000 ResponseFuncType0 |
| nPE | 13 | PEIndex | 13 | BiasFlag 0 | NumSrc 12 | Gain | 0.000000 ResponseFuncType0 |
| | nWt | 0 | Wt | −0.419812 | SrcPEIndex | 14 | |
| | nWt | 1 | Wt | −0.089983 | SrcPEIndex | 19 | |
| | nWt | 2 | Wt | −0.630034 | SrcPEIndex | 2 | |
| | nWt | 3 | Wt | −0.244771 | SrcPEIndex | 12 | |
| | nWt | 4 | Wt | 0.293635 | SrcPEIndex | 8 | |
| | nWt | 5 | Wt | 0.554794 | SrcPEIndex | 11 | |
| | nWt | 6 | Wt | 0.084393 | SrcPEIndex | 16 | |
| | nWt | 7 | Wt | 0.130026 | SrcPEIndex | 20 | |
| | nWt | 8 | Wt | −0.026370 | SrcPEIndex | 18 | |
| | nWt | 9 | Wt | 0.036230 | SrcPEIndex | 17 | |
| | nWt | 10 | Wt | −0.004463 | SrcPEIndex | 3 | |
| | nWt | 11 | Wt | 0.010368 | SrcPEIndex | 15 | |
| nPE | 14 | PEIndex | 14 | BiasFlag 0 | NumSrc 11 | Gain | 0.939403 ResponseFuncType 1 |
| | nWt | 0 | Wt | −0.840007 | SrcPEIndex | 6 | |
| | nWt | 1 | Wt | −0.714763 | SrcPEIndex | 3 | |
| | nWt | 2 | Wt | −0.476772 | SrcPEIndex | 7 | |
| | nWt | 3 | Wt | 0.135856 | SrcPEIndex | 1 | |
| | nWt | 4 | Wt | 0.228378 | SrcPEIndex | 12 | |
| | nWt | 5 | Wt | 0.574304 | SrcPEIndex | 9 | |
| | nWt | 6 | Wt | −0.147324 | SrcPEIndex | 13 | |
| | nWt | 7 | Wt | 0.449801 | SrcPEIndex | 18 | |
| | nWt | 8 | Wt | 0.239180 | SrcPEIndex | 19 | |
| | nWt | 9 | Wt | 0.065787 | SrcPEIndex | 2 | |
| | nWt | 10 | Wt | −0.047567 | SrcPEIndex | 11 | |
| nPE | 15 | PEIndex | 15 | BiasFlag 0 | NumSrc 15 | Gain | 0.807657 ResponseFuncType 1 |
| | nWt | 0 | Wt | 0.389679 | SrcPEIndex | 10 | |
| | nWt | 1 | Wt | −0.649320 | SrcPEIndex | 2 | |
| | nWt | 2 | Wt | −0.268860 | SrcPEIndex | 6 | |
| | nWt | 3 | Wt | −0.150116 | SrcPEIndex | 1 | |
| | nWt | 4 | Wt | −0.609355 | SrcPEIndex | 12 | |
| | nWt | 5 | Wt | −0.462350 | SrcPEIndex | 3 | |
| | nWt | 6 | Wt | 0.489907 | SrcPEIndex | 8 | |
| | nWt | 7 | Wt | −0.323181 | SrcPEIndex | 5 | |
| | nWt | 8 | Wt | 0.674194 | SrcPEIndex | 0 | |
| | nWt | 9 | Wt | −0.221221 | SrcPEIndex | 11 | |
| | nWt | 10 | Wt | −0.761429 | SrcPEIndex | 14 | |
| | nWt | 11 | Wt | −0.572819 | SrcPEIndex | 4 | |
| | nWt | 12 | Wt | 0.411201 | SrcPEIndex | 18 | |
| | nWt | 13 | Wt | −0.147990 | SrcPEIndex | 19 | |
| | nWt | 14 | Wt | 0.003231 | SrcPEIndex | 9 | |
| nPE | 16 | PEIndex | 16 | BiasFlag 0 | NumSrc 12 | Gain | 0.718055 ResponseFuncType 1 |
| | nWt | 0 | Wt | 0.174367 | SrcPEIndex | 1 | |
| | nWt | 1 | Wt | −2.701785 | SrcPEIndex | 11 | |
| | nWt | 2 | Wt | −0.187202 | SrcPEIndex | 20 | |
| | nWt | 3 | Wt | 1.659772 | SrcPEIndex | 7 | |
| | nWt | 4 | Wt | 1.048091 | SrcPEIndex | 8 | |
| | nWt | 5 | Wt | −0.381621 | SrcPEIndex | 9 | |
| | nWt | 6 | Wt | −2.046622 | SrcPEIndex | 10 | |
| | nWt | 7 | Wt | −0.668636 | SrcPEIndex | 12 | |
| | nWt | 8 | Wt | −2.167294 | SrcPEIndex | 14 | |
| | nWt | 9 | Wt | −0.469961 | SrcPEIndex | 18 | |
| | nWt | 10 | Wt | 0.091077 | SrcPEIndex | 5 | |
| | nWt | 11 | Wt | 0.069999 | SrcPEIndex | 3 | |
| nPE | 17 | PEIndex | 17 | BiasFlag 0 | NumSrc 13 | Gain | 1.854070 ResponseFuncType 2 |
| | nWt | 0 | Wt | −1.106495 | SrcPEIndex | 0 | |
| | nWt | 1 | Wt | −1.392413 | SrcPEIndex | 1 | |
| | nWt | 2 | Wt | −0.575998 | SrcPEIndex | 2 | |
| | nWt | 3 | Wt | 2.264917 | SrcPEIndex | 4 | |
| | nWt | 4 | Wt | −0.189249 | SrcPEIndex | 6 | |
| | nWt | 5 | Wt | 0.062955 | SrcPEIndex | 9 | |
| | nWt | 6 | Wt | 0.417983 | SrcPEIndex | 10 | |
| | nWt | 7 | Wt | 2.461647 | SrcPEIndex | 11 | |
| | nWt | 8 | Wt | −0.523990 | SrcPEIndex | 12 | |
| | nWt | 9 | Wt | 1.169054 | SrcPEIndex | 14 | |
| | nWt | 10 | Wt | 1.738452 | SrcPEIndex | 15 | |
| | nWt | 11 | Wt | −0.067326 | SrcPEIndex | 16 | |
| | nWt | 12 | Wt | 0.446668 | SrcPEIndex | 18 | |
| nPE | 18 | PEIndex | 18 | BiasFlag 0 | NumSrc 11 | Gain | 0.611935 ResponseFuncType 1 |
| | nWt | 0 | Wt | 0.430006 | SrcPEIndex | 3 | |
| | nWt | 1 | Wt | 1.186665 | SrcPEIndex | 4 | |
| | nWt | 2 | Wt | −1.792892 | SrcPEIndex | 5 | |
| | nWt | 3 | Wt | 1.781993 | SrcPEIndex | 12 | |
| | nWt | 4 | Wt | 0.077839 | SrcPEIndex | 9 | |
| | nWt | 5 | Wt | −1.572425 | SrcPEIndex | 10 | |
| | nWt | 6 | Wt | −2.016018 | SrcPEIndex | 16 | |
| | nWt | 7 | Wt | −1.904316 | SrcPEIndex | 19 | |
| | nWt | 8 | Wt | −0.041601 | SrcPEIndex | 8 | |
| | nWt | 9 | Wt | 0.011702 | SrcPEIndex | 17 | |
| | nWt | 10 | Wt | −0.042213 | SrcPEIndex | 11 | |
| nPE | 19 | PEIndex | 19 | BiasFlag 0 | NumSrc 15 | Gain | 2.080942 ResponseFuncType 0 |
| | nWt | 0 | Wt | 0.346472 | SrcPEIndex | 1 | |
| | nWt | 1 | Wt | 0.131943 | SrcPEIndex | 7 | |
| | nWt | 2 | Wt | 0.739612 | SrcPEIndex | 0 | |
| | nWt | 3 | Wt | 1.127106 | SrcPEIndex | 5 | |
| | nWt | 4 | Wt | −2.624980 | SrcPEIndex | 8 | |
| | nWt | 5 | Wt | −0.634295 | SrcPEIndex | 12 | |
| | nWt | 6 | Wt | −0.028722 | SrcPEIndex | 15 | |
| | nWt | 7 | Wt | −0.089933 | SrcPEIndex | 20 | |
| | nWt | 8 | Wt | 1.882861 | SrcPEIndex | 9 | |
| | nWt | 9 | Wt | 0.096946 | SrcPEIndex | 3 | |
| | nWt | 10 | Wt | 0.300138 | SrcPEIndex | 4 | |
| | nWt | 11 | Wt | −0.073776 | SrcPEIndex | 18 | |
| | nWt | 12 | Wt | 0.002283 | SrcPEIndex | 6 | |
| | nWt | 13 | Wt | 0.031074 | SrcPEIndex | 11 | |
| | nWt | 14 | Wt | −0.005499 | SrcPEIndex | 16 | |
| nPE | 20 | PEIndex | 20 | BiasFlag 0 | NumSrc 12 | Gain | 0.937515 ResponseFuncType 1 |
| | nWt | 0 | Wt | −1.824382 | SrcPEIndex | 0 | |
| | nWt | 1 | Wt | −1.661200 | SrcPEIndex | 1 | |
| | nWt | 2 | Wt | 1.853750 | SrcPEIndex | 5 | |
| | nWt | 3 | Wt | −2.018972 | SrcPEIndex | 6 | |
| | nWt | 4 | Wt | −2.037194 | SrcPEIndex | 7 | |
| | nWt | 5 | Wt | 0.957394 | SrcPEIndex | 19 | |
| | nWt | 6 | Wt | 0.049724 | SrcPEIndex | 10 | |
| | nWt | 7 | Wt | 0.042430 | SrcPEIndex | 11 | |
| | nWt | 8 | Wt | −0.333175 | SrcPEIndex | 15 | |
| | nWt | 9 | Wt | −0.041451 | SrcPEIndex | 17 | |
| | nWt | 10 | Wt | −0.157289 | SrcPEIndex | 9 | |
| | nWt | 11 | Wt | −0.037616 | SrcPEIndex | 14 | |
| nPE | 21 | PEIndex | 21 | BiasFlag 0 | NumSrc 7 | Gain | 1.673503 ResponseFuncType 0 |
| | nWt | 0 | Wt | 0.543390 | SrcPEIndex | 13 | |
| | nWt | 1 | Wt | −0.140907 | SrcPEIndex | 12 | |
| | nWt | 2 | Wt | −2.064485 | SrcPEIndex | 15 | |
| | nWt | 3 | Wt | −0.847448 | SrcPEIndex | 14 | |
| | nWt | 4 | Wt | −0.099563 | SrcPEIndex | 17 | |
| | nWt | 5 | Wt | 0.020631 | SrcPEIndex | 18 | |
| | nWt | 6 | Wt | 0.044644 | SrcPEIndex | 16 | |

EndNetworkData

When stored to a data file, additional parameters are added, which may include labels for the inputs parameters (derived from a presented data set), normalization constants for input and output nodes, genetic algorithm parameters, and the like.

The preferred structure of the neural network follows the form
{[Input Nodes][Interior Nodes][Output Node(s)]}

Processing elements (PE's—the nodes) appear in three distinct groups whose members occupy consecutive locations in a node array (an array of “PEData” structures). The nodes of the “Input Node” group are exactly analogous to the “External Input” nodes of a more conventional feed forward neural network and serve only as signal sources (i.e., connections may originate, but not terminate, on them). “Output Node(s)” may have any of the system-defined transfer functions (i.e., they need not be linear) and may be either targets or sources of connections (or both). “Interior Nodes”, likewise, may assume any of the system defined transfer functions and may be either targets or sources of connections (or both).

Within the software code, processing elements are represented by C structures of the following form.

TABLE 3
Software Code General Format of Processing Elements

typedef struct
{

| | | | |
|---|---|---|---|
| long | NumSourcePEs; | // | Comment: “Equal to the |
| | | | number of Source Weights |
| double | Output0[2]; | // | PE output value (0 --> |
| | | // | Current Output, |
| | | | 1 --> Next Output)” |
| | WtData*WtPtr0; | // | Comment: “Starting |
| | | // | location in memory |
| | | | for weights |
| | | | serving as inputs to a PE” |
| int | ResponseFuncType; | | |
| double | (*ResponseFunPtr)(double); | | |
| } | | | |

In embodiments for calculating the value of a single material property (e.g., Internal Bond Strength) from values of an a priori known number of process parameters acquired during composite manufacture, several geometrical constraints may be imposed on network configuration that simplify things. Specifically, the connection rules of Table 4 may be applied:

TABLE 4
Connection Rules

| | |
|---|---|
| 1) | Only External Inputs and Interior Nodes are sources for Interior |
| | Nodes. |
| 2) | Only Interior Nodes are sources for Predictive Nodes. |
| 3) | Direct Self-Linking is Forbidden (but loops are allowed). |

Successive generations of networks are produced by genetically operating on the seed neural networks, i.e., produced by manipulating the nodes and weights under the direction of the operations listed in Table 5 Note that in any particular embodiment certain of these genetic operations may be omitted.

TABLE 5
Typical Genetic Operations

| | |
|---|---|
| 1. | MateNetworks: A new network is produced by combination of the “DNA” of |
| | two parent networks. Both parents survive. |
| 2. | PruneNetwork: Inactive regions of a network are excised. In some versions of |
| | the code, the excised portions remain in the genetic “soup” for a specified |
| | number of generations and may subsequently be inserted (spliced) into an existing |
| | network. |
| 3. | InsertNetworkFragment: See “PruneNetwork” |
| 4. | PEDeletion: A processing element and its associated connections are removed from |
| | the network. |
| 5. | PEAddition: A processing element is added to the network. At least two new |
| | connections (at least one input link and at least one output link) may accompany |
| | it. The accompanying connections are placed quasi-randomly according to the |
| | rules of Table 4. |
| 6. | PEInsertion: A processing element is inserted in an existing connection that |
| | links two processing elements. One or more additional connections may |
| | accompany it. Again, the accompanying connections are placed quasi-randomly |
| | according to the rules of Table 4 |
| 7. | MutateNetworkComponent: Some component or property (e.g., the strength of a |
| | connection or the gain of a node) of an existing processing elements is modified. |
| 8. | ExchangeNetworkComponent: Two network elements (presently of the same |
| | type, node for node or weight for weight) are exchanged. If nodes are |
| | exchanged, the accompanying weights are exchanged as well. |

One consequence of the relaxed network construction rules and the resulting potential existence of closed or reentrant loops is a necessary modification of the usual manner of network processing. In all cases, at least two passes over all nodes (except for “Input Nodes”, for which no processing need be performed) is required. On each pass, inputs at each “target node” are summed. These inputs comprise signals arriving for all source nodes (i.e., for all nodes linked to the target node through the “NumSourcePEs” elements referenced by “WtPtr0”) using the “CurrentOutput” values of the source nodes. Target node outputs computed from the summed inputs are temporarily stored in the “NextOutput” locations for all (non-input) nodes. When a pass (or sweep) over all nodes and weights is complete, “NextOutput” values are copied to the “CurrentOutput” locations. Processing continues in this manner until either all outputs (or, in some versions of the code, the output of the single “output” node) stabilize or a preset number of passes over all nodes has been completed.

The ranking of genetically mediated networks is performed by the Fitness Measures included in the annotated list of Table 6. Ranking is performed after all networks have been evaluated (processed) in the context of all “training” data. It is important to note several points in connection with the fitness measures. First, in preferred embodiments the program user is permitted to establish a ranking for the fitness measures themselves. Second, the ranking determines the order in which scoring functions are applied in choosing the “best” network in a population of networks. Third, only as many scores are evaluated as are required to break all ties in computed scores. Fourth, although it is not essential to do so, as a matter of convenience, all scoring functions are normalized individually to unity. Finally, and most important, the ranking of networks under the scoring mechanism determines the order in which networks are chosen for modification by a genetic operation. The specific genetic operation selected at any point during program execution is determined at random.

TABLE 6
Fitness Measures

| | |
|---|---|
| 1. | PredictionRSqrScore: 1/(1 + SumSquaresOfResiduals) |
| 2. | SumErrFuncScore: 1 − sqrt(SumErrFuncErrors/NumDataRecords) |
| 3. | ActiveInputWtsScore: This fitness function is intended to favor |
| | networks for which the weight population for External Input |
| | Nodes is sparsest. |
| 4. | ExecutionTimeScore: This function would more accurately be named |
| | something like “ExecutionCyclesScore” since the algorithm |
| | favors those networks that reach stability in the smallest number |
| | of iterations These may not necessarily be the fastest to execute. |
| 5. | NetworkSizeScore: Compute a score that tends to favor smaller |
| | networks. |
| 6. | BestFitToStLineScore Compute a score that favors networks whose |
| | scatter diagrams fall most nearly on the 45 degree diagonal. |

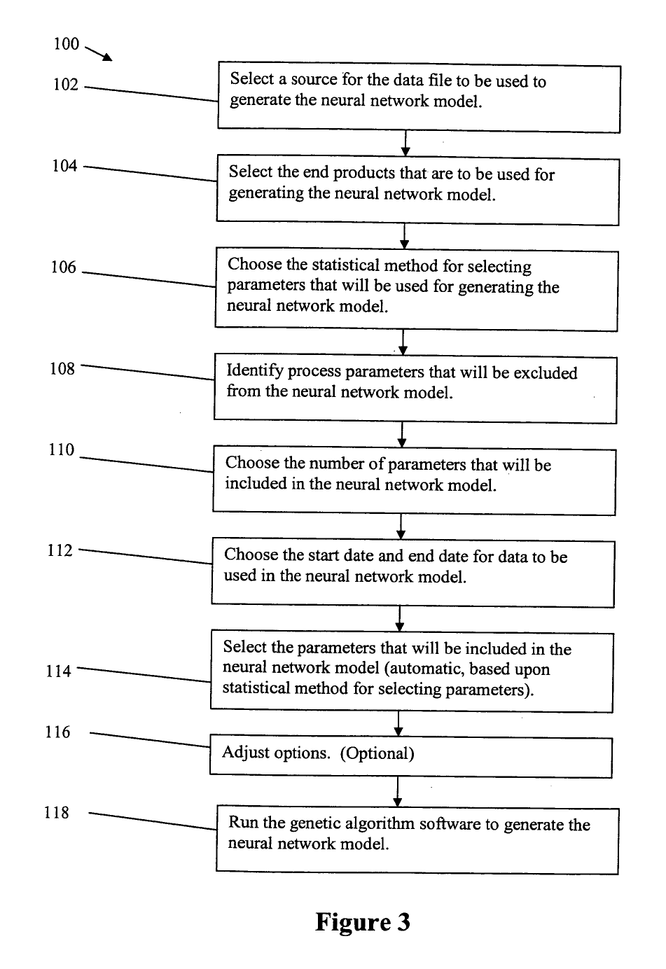

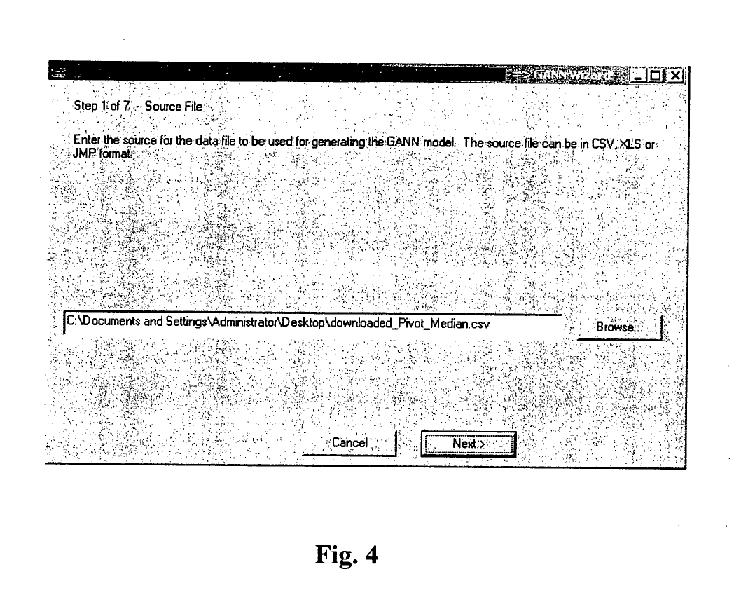

FIG. 3 depicts the overall flow of a preferred computer software embodiment 100. The first step 102 is to select a source file for generating the model. FIG. 4 illustrates this step on further detail, where the user is prompted to input the source location for data file to be used to compile the predictive model. The second step (104 in FIG. 3) is further illustrated in FIG. 4 where the user identifies the end product for which the data selected in FIG. 3 applies. In some embodiments this component of the software is automated.

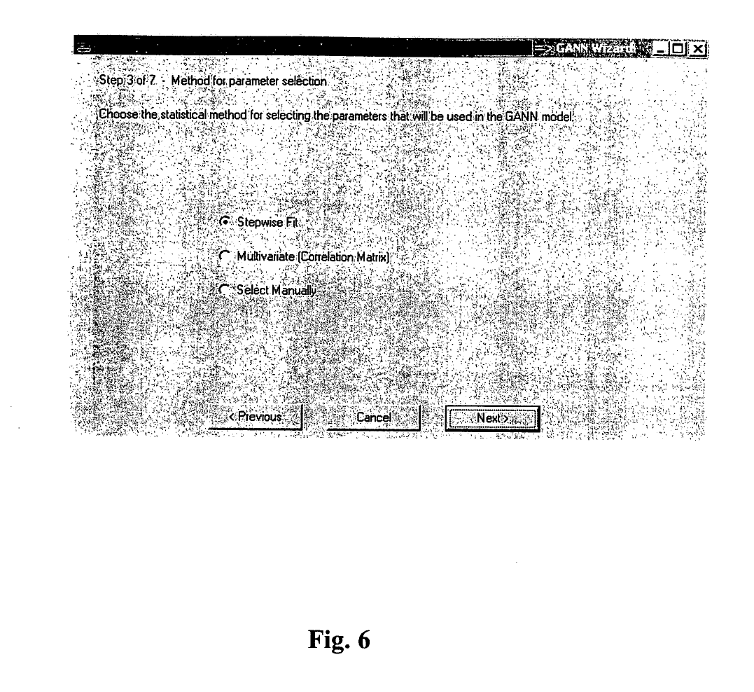

The third step (106 in FIG. 3) is to choose the statistical method for selecting parameters that will be used for generating the neural network model. Typically, hundreds of process variables are monitored and recorded for each product type. However, only a few of these variables have a significant effect on the end product property of interest. In the most preferred embodiments, a commercial statistical software package such as JMP by SAS Institute Inc. is used to identify the process variables, i.e., the process variables that have a significant effect on product characteristics. Any commercial statistical software package may be used to pre-screen parameters. In the third step, further illustrated in FIG. 6, the user selects the statistical method to be used for selecting the process variables that will be used in the neural network model. The “Stepwise Fit” and the “Multivariate (Correlation Model)” options invoke the corresponding processes from JMP to identify the statistically significant variables. The “Select Manually” option permits the user to manually pick the process variables that will be used in the neural network model.

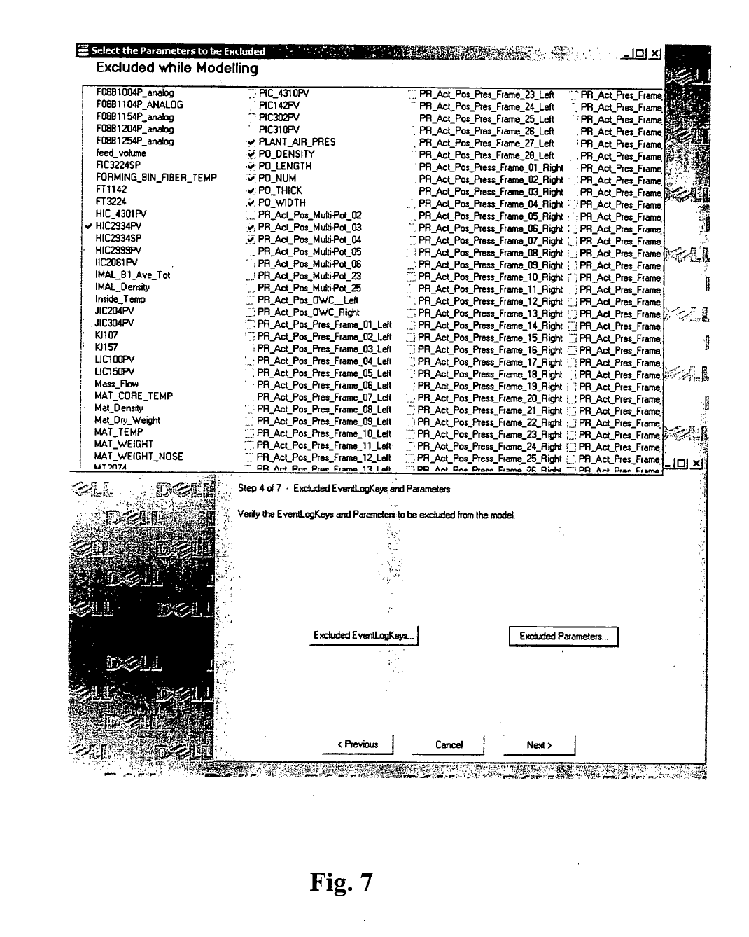

Even if an automated parameter selection process is invoked, the user may be aware of certain process variables that are inappropriate for inclusion in the analysis, and should be excluded. One possible reason for this are that the user knows that a certain sensor set was defective during the collection of the data that will be used in the analysis. To accommodate this possibility, preferred embodiments incorporate the option for the user to delete certain process variables from the modeling program, as indicated in step 108 of FIG. 3, and depicted in further detail in FIG. 7.

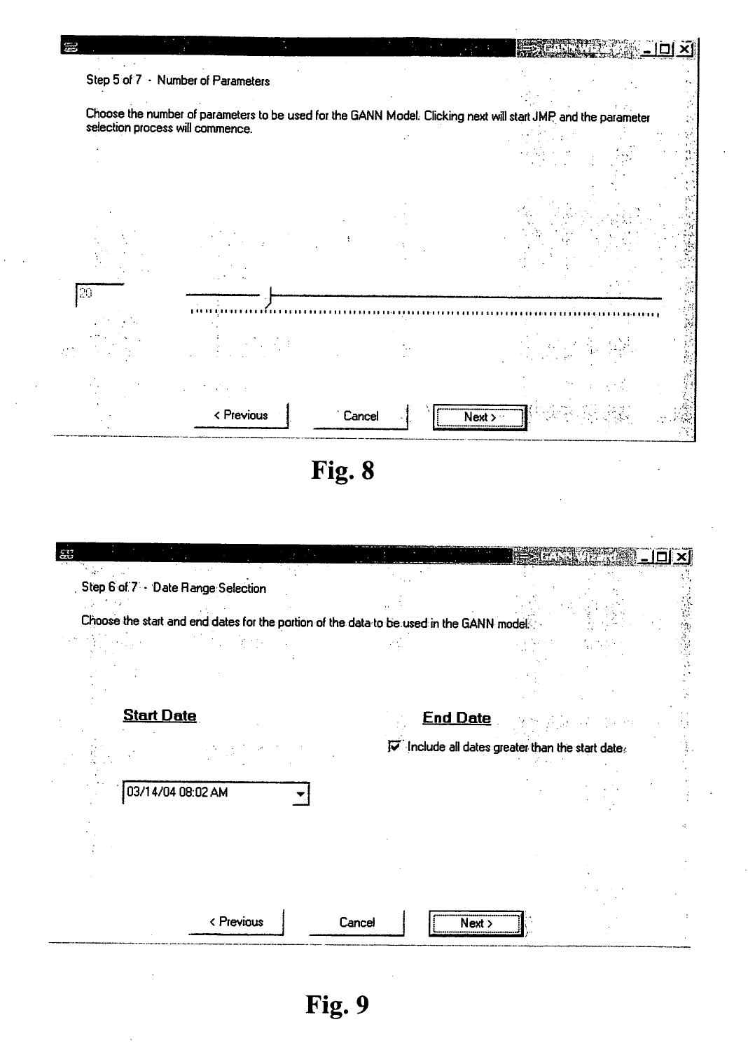

The next step, (110 in FIG. 3) is to choose the number of parameters the will be identified by the commercial statistical software package as significant to determination of the desired output property. FIG. 8 depicts a screen that allows a user to input that information. The entry of a high number may increase the accuracy of the resulting model but a high number will also increase the processing time.

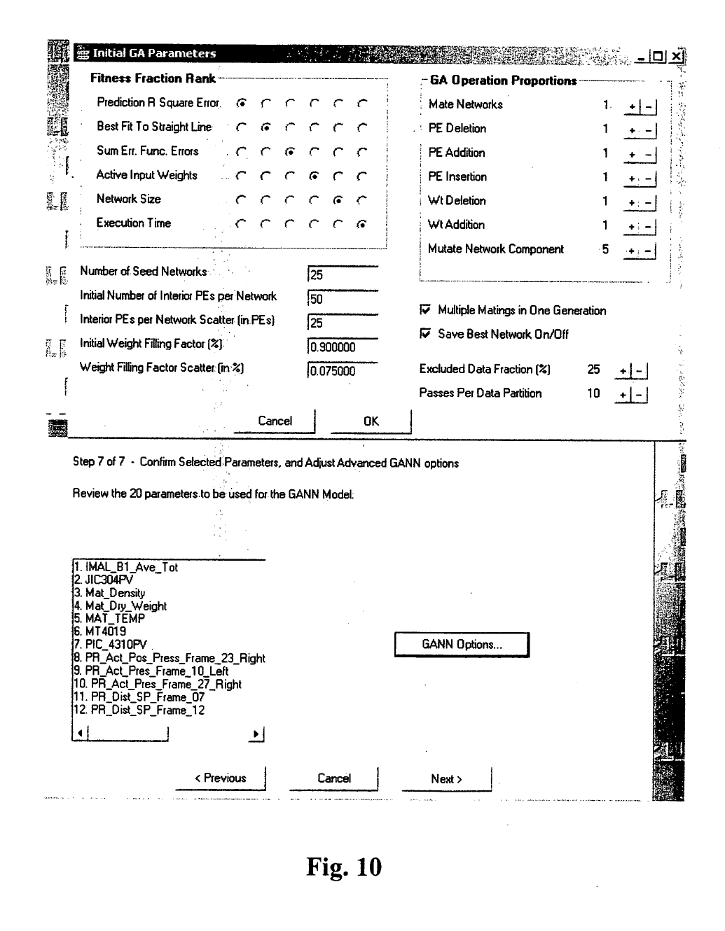

Since the contents of process variable and end property test data files may span an extended period of time, in preferred embodiments according to step 112 in FIG. 3, the user is asked, as further illustrated in FIG. 9, to indicate the time span which the analysis is to cover.

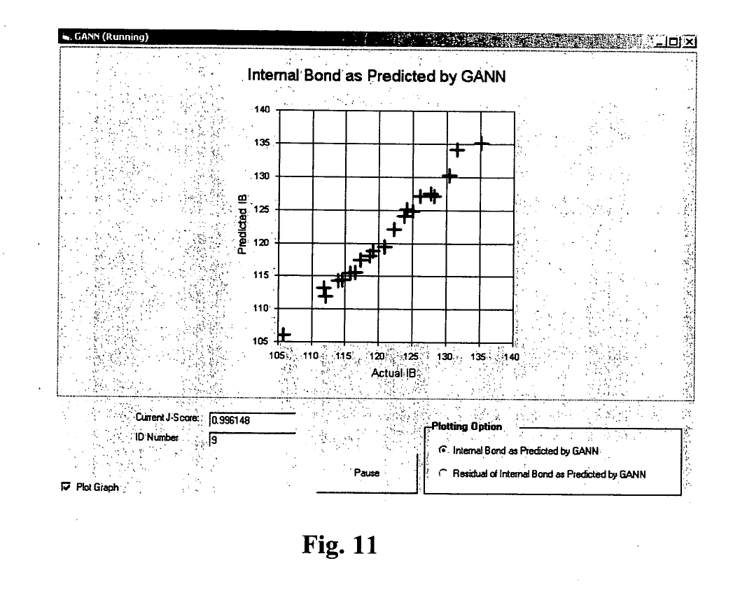

When the “Next” button at the bottom of FIG. 8 is pressed, step 114 of FIG. 3 is invoked where the commercial statistical software package (e.g., JMP) identifies the parameters to be used in the neural network models. The software then displays the most influential variables as shown in the bottom of FIG. 10. In the most preferred embodiments the user then has the option of invoking step 116 of FIG. 3 to adjust genetic algorithm processing options by pressing the “GANN Options” button at the bottom of the screen illustrated in FIG. 10 which brings up the window illustrated at the top of FIG. 10.

In the upper left portion of the upper window illustrated in FIG. 10, the user selects (from the options previously identified in Table 6) the rank order of fitness measures desired for the genetic algorithm to choose the “best” network in a population of networks. At least one fitness measure must be selected, and if more than one are selected they must be assigned a comparative rank order. J-score is the preferred higher level comparative rank order statistic relative to other statistical ranking options.

In the upper right portion of the upper window of FIG. 10, the user defines the relative usage of various genetic alternation techniques (“genetic algorithm proportion settings”) to be used by the genetic algorithm software. At least one network mating must occur and at least one processing element (PE) addition much be made and at least one weight addition must be made. The other genetic algorithm proportion settings may be set to zero. These options correlate to descriptions previously provided in Table 5. The user defines the comparative frequency at which the genetic algorithm routine will mate (cross breed) networks, and will add, delete and insert processing elements, and will add and delete weights, and will mutate network components. The selection of the comparative utilization of these techniques is learned as experience is gained in the usage of genetic algorithms. There must be a small amount of network mutation, e.g. less than 5%, but an excessive rate induces divergence instead of convergence. Most preferably, genetic algorithm rules specify that mathematical offspring from a parent may not mate with their mathematical siblings.

The process of setting genetic algorithm operational parameters continues in the lower right portion of the upper window depicted in FIG. 10 with electing whether to permit multiple matings in one generation of the process, electing whether to save the “best” network after completion, defining an excluded data fraction (validation data set), and defining the number of passes per data partition (number of iterations). At least one pass per data partition must be performed.

In the lower left portion of the upper window depicted in FIG. 10, the user defines seed network structure to be used as the starting point for the genetic algorithm process. Seed networks, are networks (i.e., a set of primary mathematical functions using the selected process parameters that predict the desired outcome) that are quasi-randomly generated from genetic primitives, e.g., set of lower order mathematical functions. The networks are “quasi-randomly” generated in sense that not all process variables are included; only those process variables that have the highest statistical correlation with product characteristic of interest are included. The seed networks comprise heuristic equations that predict an end product property based upon the previously-identified influential variables as shown in the bottom of FIG. 10. Parameters to be defined are the initial number of processing elements (PEs) per seed network, the randomness (“scatter”) in the distribution of PE's per network, initial weighting factors, and the randomness in the initial weighting factors.

The process of selecting parameters depicted in the upper window of FIG. 10 is called configuring the genetic algorithm software. This process may include any or all of the following actions: (a) selecting a fitness fraction ranking order, (b) setting genetic algorithm operational parameters, and (c) defining a seed network structure, each as illustrated in the upper window in FIG. 10.

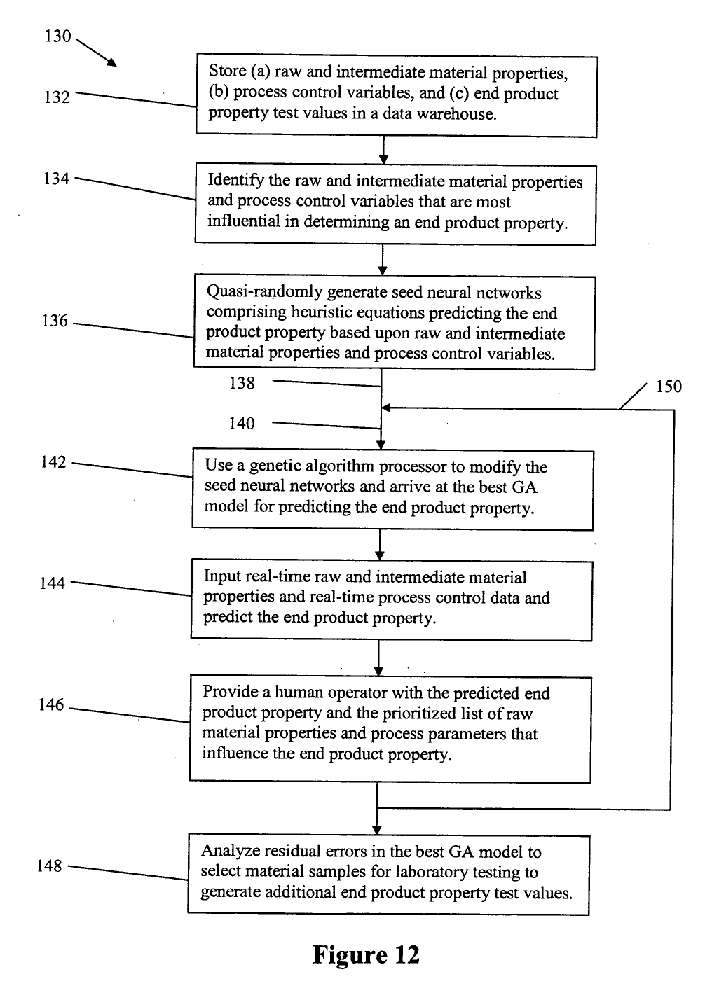

When the “Next” button on FIG. 10 is pressed, step 118 of FIG. 3 is initiated, where the genetic algorithm genetically operates on the seed networks, creating a fitness measure (e.g., “J-score”) for the each network. This process continues for as long as is required to effect satisfactory network optimization according to the general prescriptions set forth in Table 1 and Table 5 until the “optimal model” is generated. The “optimal” model may not be the absolute best model that could be generated by a genetic algorithm process, but it is the model that results from the conclusion of the process defined in Table 1. Then the results are used to prepare plots as illustrated in FIG. 11. Optionally, there is a pause button on the screen as shown in FIG. 10. This screen is continually updated as the genetic algorithm software runs, and it can be paused. Actual versus predicted internal bond values are plotted, with the actual value for a given end product test sample being plotted on the abscissa and the predicted internal bond strength (based on the process variable values for that sample) being plotted on the ordinate.

In principle, it is possible to write down an expression for the overall transfer function of the neural network generated by the genetic algorithm operations (or for any network, for that matter). However, the function would be a piecewise one and so complex in form as to render it almost completely useless for analytical purposes. The best representation of the network is the network itself. A network of linear and/or non-linear equations are created and the real-time data are processed through this network of a system of equations to produce a prediction. The genetic algorithm system serves only as a mechanism for generating network solutions using operations roughly analogous to those performed in during the course of biological evolution. Thus, the genetic algorithm portion of the system is merely an optimizer that creates the optimal model. The optimal model is a network of linear and/or non-linear equations incorporating the process variables and at least one product characteristic where the model optimally predicts at least one product characteristic.

In the most preferred embodiments, the optimal model is run in real time as a production plant operates and process control data are fed into the optimal neural network model. “Process control data” refers to process variable data that are captured (either transiently or storably) preferably (but not necessarily) in real time, as the production process operates. Projected end product property values (based on the optimal neural network model) are reported to production control specialists, along with a ranked order (as determined by the commercial statistical software package) of the process variables that are most influential in determining each end product property value. If a end product property value is projected (predicted) to be out of tolerance or headed out of tolerance, the production control operator may use his/her background experience and knowledge of process control settings and their relationship with process variables to adjust one or more process control settings to modify one or more of the influential process variables and thereby control the production process, i.e., bring the projected (and it is hoped the resultant actual) end product property value closer to the desired value.

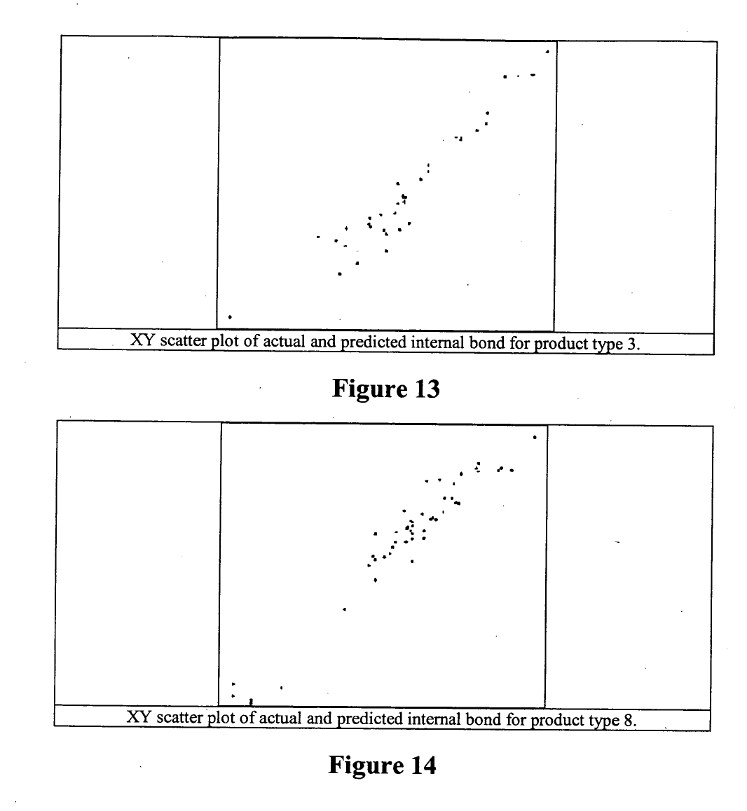

FIG. 12 illustrates an embodiment using a genetic algorithm process with a data warehouse to provide information used to control a production operation. Typically an automated relational database is used, and in the most preferred embodiments the data warehouse operates under Microsoft Structured Query Language (SQL). The method 130 begins with step 132 in which a data warehouse is established as a repository for measured raw and intermediate material property data and process control settings that are associated with product characteristics. In step 134, the raw material and intermediate material properties, and the process control variables that have the most significant influence in determining a selected end product property are identified. As previously indicated, raw and intermediate material properties, and process control variables, or a combination thereof are called “process variables.” In the most preferred embodiments, a commercial software statistical analysis package is used to identify the most significant process variables.

Next, as depicted in step 136, quasi-randomly generated heuristic equations are created to predict end product properties based upon the influential raw and intermediate material properties and process control variables. These quasi-randomly generated set of functions of process variables that will be used to predict end property characteristics. Typically, some initial quasi-randomly created functions predict the end property value quite poorly and some predict the end property characteristics quite well.

The process then moves through flow paths 138 and 140 to step 142 where the genetic algorithm software discards the worst functions and retains the better functions. Then the most important function of the genetic analysis—the mating or crossover function—mates a small percentage (typically one percent) of the pairs of the better performing functions to produce “offspring functions” that are evaluated for their predictive accuracy. This process continues until for as long as is required to effect satisfactory network training according to the general prescriptions set forth in Table 1 and Table 5. Typically, training requires approximately ten thousand generations (where a generation is one complete pass over the algorithm of Table 1 for all members of one data set). In the interest of execution speed, network populations may pruned when the number of networks for any data set exceeds some reasonable upper limit, such as 64.

After the optimal genetic algorithm model is developed, the process continues to step 144 where real-time process variables (raw and intermediate material values, process control variables, etc.) from an actual production process may be entered into the model and an end product property value. That predicted (or projected) value, plus the ranked order list of process variables that affect the end product property value (determined in step 134) are provided to a production control operator in step 146. The production control operator may adjust some of the process variables to improve the predicted end property product value.

In step 148, residual errors from the optimal genetic algorithm model are analyzed to determine what additional tests should be run to update one or more process variables in the database management system, or acquire additional product characteristic data. This analysis of residuals is part of the experience level of the user of the system. If patterns in the residuals are detectable, a new network is explored and the system is re-run. After additional testing is completed the results are fed back into the process through flow paths 150 and 140.

### EXAMPLE

A heuristic algorithmic method of using genetic algorithms (genetic algorithm) with distributed data fusion was developed to predict the internal bond of medium density fiberboard (MDF). The genetic algorithm was supported by a distributed data fusion system of real-time process parameters and destructive test data. The distributed data fusion system was written in Transaction—Structured Query Language (T-SQL) and used non-proprietary commercial software and hardware platforms. The T-SQL code was used with automated Microsoft SQL functionality to automate the fusion of the databases. T-SQL encoding and Microsoft SQL data warehousing were selected given the non-proprietary nature and ease of use of the software. The genetic algorithm was written in C++.

The hardware requirements of the system were two commercial PC-servers on a Windows 2000 OS platform with a LAN Ethernet network. The system was designed to use non-proprietary commercial software operating systems and “over the counter” PC hardware.

The distributed data fusion system was automated using Microsoft SQL “stored procedures” and “jobs” functions. The system was a real-time system where observations from sensors were stored in a real-time Wonderware™ Industrial Applications Server SQL data warehouse. Approximately 285 out of a possible 2,500 process variables were stored in the distributed data fusion system. The 285 process variables were time-lagged as a function of the location of the sensor in the manufacturing process. Average and median statistics of all process parameters were estimated. The physical property of average internal bond in pounds per square inch (psi) estimated from destructive testing was aligned with the median, time-lagged values of the 285 process variables. This automated alignment created a real-time relational database that was the infrastructure of the distributed data fusion system.

Genetic algorithms as applied to the prediction of the internal bond of MDF began with a randomly generated trial of a high-level description of the mathematical functions for prediction, i.e., the initial criteria for scoring the functions of the process variables fitness. The fitness of the function was determined by how closely the mathematical functions followed the actual internal bond. Some randomly created mathematical functions predicted actual internal bond quite well and others quite poorly. The genetic algorithm discarded the worst mathematical functions in the population, and applied genetic operations to surviving mathematical functions to produce offspring. The genetic algorithm function of mating (crossover) mated pairs of mathematical functions that were better performing functions which produced an offspring of mathematical functions that were better predictors. For example, mating the functions (2.5a+1.5) and 1.3(a×a) produced a mathematical offspring function of 1.3((2.5a+1.5)×a). This recombination of mathematical functions was used iteratively until superior offspring mathematical functions no longer could be produced. One percent of the functions were randomly mutated during recombination in the hope of producing a superior mathematical predictive function.

The objective of the genetic algorithm was to predict the internal bond of MDF. The “J-Score” (a statistic is related to the R² statistic in linear regression analysis), defined as: 1/(1+Sum Squares of Residuals)) was used as a fitness indicator statistic.

In order to verify that initially observed results were not a singular aberration, the records for each data set (each data set and its corresponding network population comprised a separate and independent batch processing task) were successively divided into two groups comprising 75 and 25 percent of the records. Upon each such division, network conditioning would be allowed in the context of the larger group for ten generations. Processing occurred for members of the smaller group, but results were used only for display purposes. Processing results for the smaller group did not contribute to the scores used for program ranking. At the end of the ten generations, the full data set was subdivided again into two groups of 75 and 25 percent with different, but randomly selected, members. The intent of the above described method was to force an environment in which only those networks that evolved with sufficient generality to deal with the changing training environment could survive.

genetic algorithm solutions were segregated into five product types produced by the manufacturer. Results are presented in Table 7 for these product type groupings. A graphical representation of the correlations between projected internal bond strength and measured internal bond strength is portrayed for each product type grouping in Figures A-E, as indicated.

TABLE 7
genetic algorithm Results Summary

| | | No. of Significant | | Figure |
|---|---|---|---|---|
| | | Process | No. of | Depicting |
| Product Type | J-Score | Parameters | Iterations | Results |
| 3 | 0.91 | 14 | 355 | |
| 8 | 0.89 | 14 | 746 | |
| 9 | 0.88 | 10 | 653 | |
| 7 | 0.92 | 10 | 687 | |
| 4 | 0.94 | 10 | 732 | |

The identification of significant process parameters represents a key feature of the predictive system. In two cases (Products 3 and 8) the system identified fourteen process factors that were important in the formation of an end product quality, namely the internal bond strength of MDF. In three cases (Products 9, 7, and 4), ten process factors were identified as important to internal bond strength.

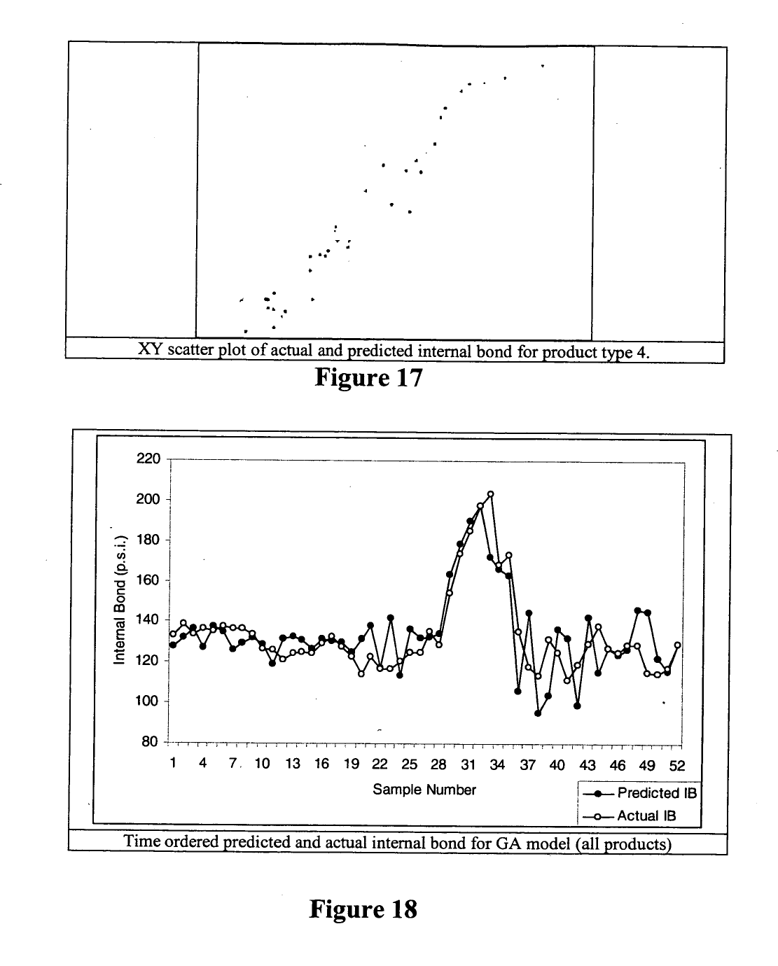

The mean and median residuals for all products were 1.19 and −0.13 psi., respectively as shown in Table 8. The genetic algorithm predictions of internal bond tended to follow actual internal bond time trends (FIG. 18). Time-ordered residuals tended to be non-homogeneous. There was statistical evidence to indicate that the residuals were approximately normal (Table 9), but were slightly non-homogeneous at the end of the validation.

The mean and median residuals for four of the five product types were less than four pounds per square inch (psi), see Table 8. The residual value is equal to the projected internal bond minus the actual measured internal bond.

Product type 4 was the worst performer and had a mean residual of 9.06 psi. Product types 3, 8, 9 and 7 had time-ordered residuals that tended to follow the actual internal bond time-ordered trend. The large mean residual for product type 4 was heavily influenced by the third sample validation residual of 24.90 psi.

TABLE 8
Validation results of genetic algorithm model at MDF manufacturing site.

| Product | Mean | Median | Residual | Minimum | Maximum | |
|---|---|---|---|---|---|---|
| ID | Residual | Residual | Std. Dev. | Residual | Residual | N |
| 3 | 0.56 | −3.37 | 11.01 | −1.46 | 17.39 | 20 |
| 8 | −3.00 | −3.56 | 23.08 | 11.29 | −29.66 | 8 |
| 9 | 3.05 | −0.06 | 14.56 | −0.06 | −22.88 | 9 |
| 7 | −3.60 | −0.20 | 13.91 | −0.20 | −31.74 | 7 |
| 4 | 9.06 | 8.85 | 12.34 | 0.71 | 24.90 | 8 |
| All | 1.19 | −0.13 | 14.55 | −0.20 | −31.74 | 52 |

TABLE 9
Shapiro-Wilk W test for normality of residuals (product
types 3, 8, 9, 7 and 4).

| | | | | | Shapiro- | |
|---|---|---|---|---|---|---|
| | Param- | Esti- | Lower | Upper | Wilk | |
| Type | eter | mate | 95% | 95% | W Test | Prob < W |
| Location | μ | 1.19 | −2.89 | 5.24 | 0.9794 | 0.5023 |
| Dispersion | σ | 14.55 | 12.19 | 18.04 | | |

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for controlling a process for producing a product, the method comprising:
providing a set of seed neural networks corresponding to the process;
using genetic algorithm software to genetically operate on the seed neural networks to predict a characteristic of the product made by the process;
based upon the predicted characteristic of the product, manually adjusting the process to improve the predicted characteristic of the product.

2. A method for controlling a process for producing a product, the method comprising:
providing process variable data associated with a product characteristic data, a set of process variables that are influential in affecting a product characteristic, and seed neural networks incorporating the process variables and the product characteristic;
using genetic algorithm software to genetically operate on the seed neural networks and arrive at an optimal model for predicting the product characteristic based upon the process variable data associated with the product characteristic data;
inputting process control data from the product production process into the optimal model and using the process control data to calculate a projected product characteristic;
based on the projected product characteristic, manually adjusting at least one process variable to control the process.

3. The method of claim 2 wherein the projected product characteristic comprises a product output rate.

4. The method of claim 3 wherein the projected product characteristic comprises a material consumption rate.

5. The method of claim 4 further comprising the step of updating process variable data in real time.

6. The method of claim 5 wherein the step of calculating a projected product characteristic comprises calculating residual errors and the method further comprises the step of analyzing the residual errors and selecting at least one material sample for laboratory testing to generate additional product characteristic data.

7. The method of claim 2 wherein the projected product characteristic comprises a material consumption rate.

8. The method of claim 7 further comprising the step of updating process variable data in real time.

9. The method of claim 8 wherein the step of calculating a projected product characteristic comprises calculating residual errors and the method further comprises the step of analyzing the residual errors and selecting at least one material sample for laboratory testing to acquire additional product characteristic data.

10. The method of claim 2 further comprising the step of updating process variable data in real time.

11. The method of claim 1 0 wherein the step of calculating a projected product characteristic comprises calculating residual errors and the method further comprises the step of analyzing the residual errors and selecting at least one material sample for laboratory testing to acquire additional product characteristic data.

12. The method of claim 2 wherein the step of calculating a projected product characteristic comprises calculating residual errors and the method further comprises the step of analyzing the residual errors and selecting at least one material sample for laboratory testing to acquire additional product characteristic data.

13. A method for generating a neural network model for a product production process, the method comprising:
(a) providing a parametric dataset that associates process variable data with product characteristic data;
(b) generating a set of seed neural networks using the parametric dataset;
(c) defining a fitness fraction ranking order, genetic algorithm proportion settings, and a number of passes per data partition for a genetic algorithm software code;
(d) using the genetic algorithm software code to modify the seed neural networks and create an optimal model for predicting a product characteristic based upon the process variable data.

14. The process of claim 13 further comprising selecting process variable data that will be excluded from the genetic algorithm model.

15. The process of claim 14 wherein step (a) comprises providing a parametric dataset that includes median values of material properties.

16. The process of claim 12 wherein step (a) comprises providing a parametric dataset that includes median values of material properties.

17. A method for controlling a product production process, the method comprising:
providing a parametric dataset that associates process variable data with product characteristic data;
quasi-randomly generating a set of seed neural networks using the parametric dataset;
using a genetic algorithm software code to create an optimal model from the set of seed neural networks;
inputting process control data from the product production process into the optimal model and using the process control data to calculate a projected product characteristic;
based on the projected product characteristic, adjusting at least one process variable to control the process.

18. The method of claim 17 wherein the projected product characteristic comprises a product output rate.

19. The method of claim 17 wherein projected product characteristic comprises a material consumption rate.

20. The method of claim 17 further comprising the step of updating process variable data in real time.

21. The method of claim 17 wherein the step of calculating a projected product characteristic comprises calculating residual errors and the method further comprises the step of analyzing the residual errors and selecting at least one material sample for laboratory testing to acquire additional product characteristic data.
